(19) United States
(12) Patent Application Publication
(10) Pub. No.: US 2011/0096050 A1
(43) Pub. Date: Apr. 28, 2011

(54) LIQUID CRYSTAL DISPLAY AND METHOD OF DRIVING THE SAME

(75) Inventors: Jae-Sic LEE, Yongin-City (KR); Chul-Ho Kim, Yongin-City (KR); Dong-Hoon Lee, Yongin-City (KR)

(73) Assignee: Samsung Mobile Display Co., Ltd., Yongin-City (KR)

(21) Appl. No.: 12/818,373

(22) Filed: Jun. 18, 2010

(30) Foreign Application Priority Data
Oct. 28, 2009 (KR) 10-2009-0102716

(51) Int. Cl. G09G 3/36; G09G 5/00

(52) U.S. Cl. 345/209; 345/211; 345/96

(57) ABSTRACT

A liquid crystal display including a liquid crystal panel having n gate lines and m data lines intersecting one another to form a frame to display an image; a gate driving unit supplying a scan signal to the n gate lines arranged in rows on the liquid crystal panel; a data driving unit supplying a data signal to the m data lines arranged in columns on the liquid crystal panel; and a common voltage driving unit applying a first common voltage to a plurality of odd common voltage lines arranged in rows on the liquid crystal panel, and applying a second common voltage to a plurality of even common voltage lines, wherein the odd common voltage lines and the even common voltage lines are alternately arranged in rows.

### CROSS-REFERENCE TO RELATED APPLICATION

This application claims the benefit of Korean Patent Application No. 10-2009-0102716, filed Oct. 28, 2009, in the Korean Intellectual Property Office, the disclosure of which is incorporated herein by reference.

### BACKGROUND

1. Field

Aspects of the present invention relate to a liquid crystal display (LCD) device and a method of driving the same, and more particularly, to an LCD device that operates based on an inversion drive scheme and a method of driving the LCD device.

2. Description of the Related Art

Liquid crystal display (LCD) devices are manufactured by forming a liquid crystal layer having an anisotropic dielectric constant between upper and lower substrates that are transparent insulating substrates. In such an LCD device, an image is displayed by altering the arrangement of liquid crystal by controlling the intensity of an electric field generated in the liquid crystal layer in order to adjust the amount of light that permeates the upper substrate that is a display surface. A representative example of an LCD device is a thin film transistor (TFT) LCD device that uses a TFT as a switching device.

If a direct current (DC) bias is applied to both ends of liquid crystal contained in an LCD device in order to drive such a liquid crystal panel, then the properties of the liquid crystal may be degraded. Thus, in order to prevent this problem and enhance the quality of an image displayed, an inversion drive scheme is established in which an LCD device is driven while polarity inversion is performed in predetermined units.

FIG. 1 illustrates various representative inversion drive schemes. Referring to FIG. 1, inversion drive schemes are classified into a frame inversion scheme, a line inversion scheme, a column inversion scheme, and a dot inversion scheme according to how the polarity inversion is performed.

### SUMMARY

Aspects of the present invention provide a liquid crystal display (LCD) device that operates based on an inversion drive scheme and a method of driving the same.

According to an aspect of the present invention, there is provided a liquid crystal display including a liquid crystal panel having n gate lines and m data lines intersecting one another to form one frame to display an image; a gate driving unit respectively supplying a plurality of scan signals to the n gate lines arranged in rows on the liquid crystal panel; a data driving unit respectively supplying a plurality of data signals to the m data lines arranged in columns on the liquid crystal panel; and a common voltage driving unit applying a first common voltage to a plurality of odd common voltage lines arranged in rows on the liquid crystal panel, and applying a second common voltage to a plurality of even common voltage lines arranged in rows on the liquid crystal panel, where the odd common voltage lines and the even common voltage lines are alternately arranged.

According to another aspect of the present invention, pixels in odd-numbered rows may be connected to the odd common voltage lines, and wherein pixels in even-numbered rows may be connected to the even common voltage lines.

According to another aspect of the present invention, the frame may be divided into an odd-numbered frame and an even-numbered frame, and wherein common voltage polarity inversion may be performed such that a polarity of the odd-numbered frame is opposite to a polarity of the even-numbered frame.

According to another aspect of the present invention, in the odd-numbered frame, the common voltage driving unit may apply the first common voltage to the odd common voltage lines and apply the second common voltage to the even common voltage lines. In the even-numbered frame, the common voltage driving unit may apply the second common voltage to the odd common voltage lines and apply the first common voltage to the even common voltage lines.

According to another aspect of the present invention, charge sharing may be applied between the first common voltage and the second common voltage in order to perform common voltage polarity inversion.

According to another aspect of the present invention, a polarity of a pulse waveform of the first common voltage is inverted compared to a polarity of a pulse waveform of the second common voltage.

According to another aspect of the present invention, there is provided a method of driving a liquid crystal display device having a liquid crystal panel, gate lines supplying a plurality of scan signals, data lines supplying a plurality of data signals, a plurality of odd common voltage lines applying a first common voltage and being arranged in rows on the liquid crystal panel, and a plurality of even common voltage lines applying a second common voltage and being arranged in rows on the liquid crystal panel, such that the odd common voltage lines and even common voltage lines are alternately arranged, the method including supplying, respectively, the plurality of scan signals to gate electrodes in an odd-numbered frame or an even-numbered frame; and applying, respectively, the plurality of data signals and a first common voltage or a second common voltage, having a first polarity, to pixels in rows, in response to the scan signals.

According to another aspect of the present invention, wherein the supplying in the odd-numbered frame includes supplying a first scan signal to a first gate line connected to pixels in a first row; supplying a data signal to the pixels in the first row, via one of the data lines, and applying the first common voltage to the pixels in the first row, via one of the odd common voltage lines, in response to the first scan signal so that the pixels in the first row have a predetermined polarity; supplying a second scan signal to a second gate line connected to pixels in a second row; and supplying a data signal to the pixels in the second row, via one of the data lines, and applying the second common voltage to the pixels in the second row, via one of the even common voltage lines, in response to the second scan signal so that the pixels in the second row have a predetermined polarity.

According to another aspect of the present invention, wherein the supplying in the even-numbered frame includes supplying a first scan signal to a first gate line connected to pixels in a first row; supplying a data signal to the pixels in the first row, via one of the data lines, and applying the second common voltage to the pixels in the first row, via one of the odd common voltage lines, in response to the first scan signal so that the pixels in the first row have a predetermined polarity; supplying a second scan signal to a second gate line connected to pixels in a second row; and supplying a data signal to the pixels in the second row, via one of the data lines, and applying the first common voltage to the pixels in the second row, via one of the even common voltage lines, in response to the second scan signal so that the pixels in the second row have a predetermined polarity.

According to another aspect of the present invention, a polarity of a pulse waveform of the first common voltage is inverted compared to a polarity of a pulse waveform of the second common voltage.

According to another aspect of the present invention, the pixels in the first row may be connected to one of the odd common voltage lines, and the pixels in the second row may be connected to one of the even common voltage lines.

According to another aspect of the present invention, the pixels in the first row may be connected to one of the odd common voltage lines, and the pixels in the second row may be connected to one of the even common voltage lines.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates various representative inversion drive schemes;

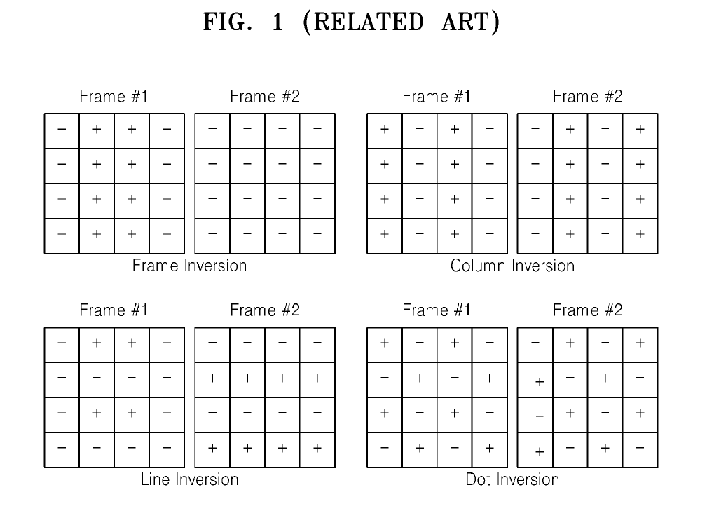

FIG. 2 is a schematic block diagram of a liquid crystal display (LCD) device according to an embodiment of the present invention;

FIG. 3 illustrates a common voltage driving unit and a plurality of common voltage lines included in the LCD device of FIG. 2, according to an embodiment of the present invention;

FIG. 4 illustrates in detail a liquid crystal panel of the LCD device of FIG. 2;

FIG. 5 is a timing diagram of a method of driving an LCD device according to an embodiment of the present invention;

FIG. 6 is a flowchart illustrating a method of driving an LCD device according to an embodiment of the present invention;

FIG. 7 illustrates polarities of frames in an LCD device based on the timing diagram of FIG. 5, according to an embodiment of the present invention;

FIGS. 8A-8B illustrate the results of applying charge sharing to an LCD device according to an embodiment of the present invention; and

FIGS. 9A-9B illustrate the results of applying charge sharing to a data signal according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

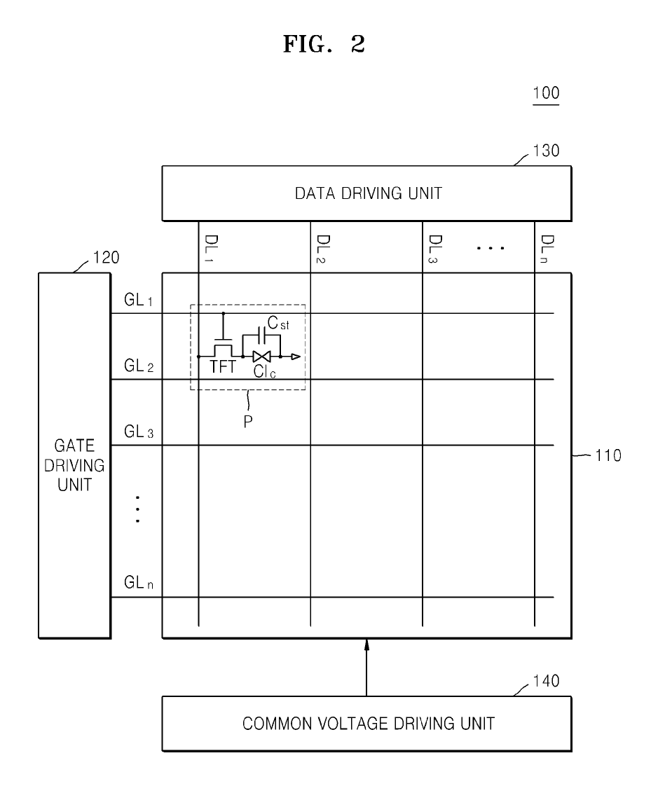

FIG. 2 is a schematic block diagram of a liquid crystal display (LCD) device 100 according to an embodiment of the present invention. Referring to FIG. 2, the LCD device 100 includes a liquid crystal panel 110, a gate driving unit 120, a data driving unit 130, and a common voltage driving unit 140.

In the liquid crystal panel 110, m data lines DL₁, DL₂, DL₃, . . . to DLₘ in a column and n gate lines GL₁, GL₂, . . . to GLₙ in a row are arranged in a matrix to intersect one another. In the liquid crystal panel 110, m×n pixels P are formed at points where the m data lines DL₁, DL₂, DL₃, . . . to DLₘ and the n gate lines GL₁, GL₂, . . . to GLₙ intersect one another.

Each of the pixels P includes a thin film transistor (TFT), a liquid crystal cell Cl_{c}, a capacitor Cₛₜ, etc. A gate electrode of the TFT is connected to the gate line GL₁, GL₂, . . . or GLₙ and a source electrode thereof is connected to the data line DL₁, DL₂, DL₃, . . . or DLₘ. A drain electrode of the TFT is connected to the liquid crystal cell Cl_{c}. The liquid crystal cell Cl_{c} includes a common electrode and a pixel electrode. The pixel electrode is connected to the drain electrode of the TFT, having liquid crystal therebetween. The common electrode is connected to a common voltage line so that a common voltage Vcom is applied to the common electrode.

The pixel P includes the capacitor Cₛₜ which stably retains a data signal supplied to the liquid crystal cell Cl_{c} until a subsequent data signal is supplied to the liquid crystal cell Cl_{c}. The capacitor Cₛₜ is disposed in parallel with the liquid crystal cell Cl_{c}, such that one end of the capacitor Cₛₜ is connected to the pixel electrode and the other end thereof is connected to the common electrode. However, aspects of the present invention are not limited thereto. For example, one end of the capacitor Cₛₜ is connected to the pixel electrode of the liquid crystal cell Cl_{c} and another end thereof is connected to the gate line connected to the preceding pixel P of the current pixel P.

The gate driving unit 120 supplies a scan signal sequentially to the gate lines GL₁, GL₂, . . . to GLₙ. If the TFT is connected to the gate line GL₁, GL₂, . . . or GLₙ, and is supplied the scan signal, the TFT is turned on.

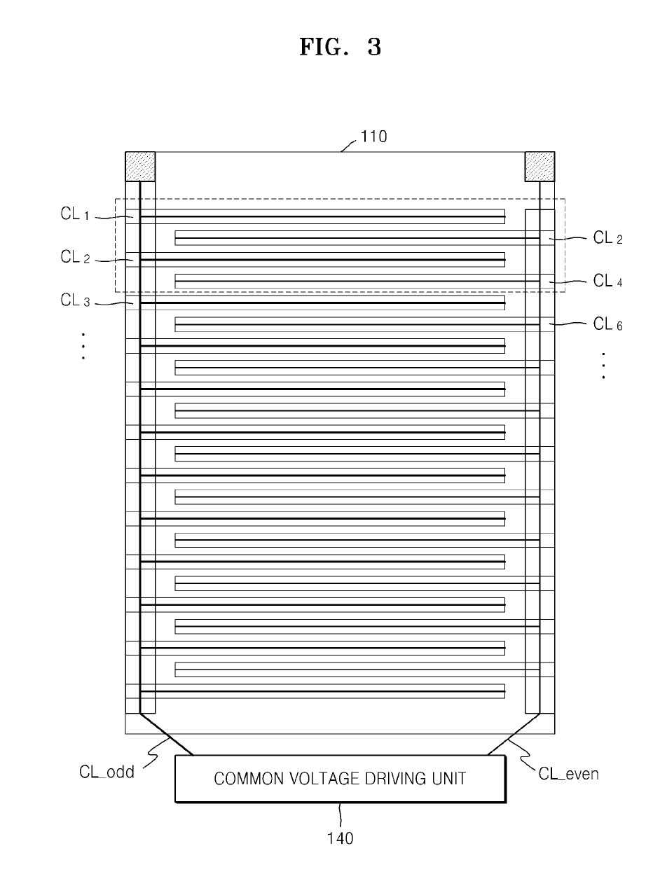

The data driving unit 130 supplies a data signal to the data lines DL₁, DL₂, DL₃, . . . to DLₘ. The data driving unit 130 supplies the data signal corresponding to one of the rows of gate lines to the data lines DL₁, DL₂, DL₃, . . . to DLₘ during each pulse duration in which the scan signal is supplied to the gate lines GL₁, GL₂, . . . to GLₙ. The common voltage driving unit 140 applies the common voltage Vcom to the common voltage line. The common voltage driving unit 140 and the common voltage line will be described in detail later with reference to FIG. 3.

Although not shown in the drawings, the LCD device 100 illustrated in FIG. 2 may further include a timing controller that generates a control signal controlling the gate driving unit 120, the data driving unit 130, and the common voltage driving unit 140.

A method of displaying gray-scales of the LCD device 100 of FIG. 2 will now be described focusing on one of the pixels P. If a scan signal that is logic high is supplied to the first gate line GL₁, then the TFT included in the pixel P is turned on. The turned-on TFT supplies the data signal received via the first data line DL₁ to the pixel electrode of the liquid crystal cell Cl_{c}. In this case, a particular common voltage Vcom is applied to the common electrode of the liquid crystal cell Cl_{c}, and thus, a predetermined voltage difference occurs between the pixel electrode and the common electrode.

If a scan signal that is logic low is supplied to the first gate line GL₁, then the TFT is turned off to allow the data signal to be continuously retained in the liquid crystal cell Cl_{c}. An electric field is generated by the difference between the voltage of the supplied data signal and the common voltage Vcom applied to the common electrode, and changes the arrangement of liquid crystal having an anisotropic dielectric constant and that is contained in the liquid crystal cell Cl_{c}. A change in the arrangement of the liquid crystal leads to a change in the transmissivity of light emitted from a backlight (not shown), thereby displaying gray-scales.

FIG. 3 illustrates in detail the common voltage driving unit 140 and n common voltage lines CL₁, CL₂, CL₃ . . . to CLₙ included in the LCD device 100 of FIG. 2. Referring to FIG. 3, the common voltage driving unit 140 applies a common voltage Vcom to the common voltage lines CL₁, CL₂, CL₃ . . . to CLₙ.

The common voltage lines CL₁, CL₂, CL₃ . . . to CLₙ are connected to common electrodes of respective pixels (not shown) in order to apply the common voltage Vcom to the pixels. The common voltage lines CL₁, CL₂, CL₃ . . . to CLₙ are arranged in rows in the liquid crystal panel 110.

The common voltage lines CL₁, CL₂, CL₃, . . . to CLₙ are divided into odd common voltage lines CL₁, CL₃, . . . CL_{1+N} (wherein N is an even number) and even common voltage lines CL₂, CL₄, . . . CL_{2+N}. However, aspects of the present invention are not limited thereto and the number of even common voltage lines does not need to be equal to the number of odd common voltage lines. The common voltage driving unit 140 applies different common voltages to the odd common voltage lines CL₁, CL₃ . . . CL_{1+N} and the even common voltage lines CL₂, CL₄ . . . CL_{2+N}. Referring to FIG. 3, different common voltages are applied to the odd common voltage lines CL₁, CL₃ . . . CL_{1+N}, and to the even common voltage lines CL₂, CL₄ . . . CL_{2+N} via an output terminal CL_odd and an output terminal CL_even of the common voltage driving unit 140, respectively. The common voltage applied to the odd common voltage lines CL₁, CL₃, . . . CL_{1+N} via the output terminal CL_odd are applied to the common electrodes of the corresponding pixels, and the common voltage applied to the even common voltage lines CL₂, CL₄, . . . CL_{2+N} via the output terminal CL_even are applied to the common electrodes of the corresponding pixels.

For example, in a particular frame, the odd common voltage lines CL₁, CL₃, . . . CL_{1+N} are connected to pixels in odd-numbered rows in order to apply a first common voltage to these pixels, and the even common voltage lines CL₂, CL₄, . . . CL_{2+N} are connected to the other pixels in even-numbered rows in order to apply a second common voltage to the other pixels.

In the current embodiment, the common voltage lines CL₁, CL₂, CL₃, . . . to CLₙ and the pixels are connected via a connection unit (not shown) formed of an indium-tin-oxide (ITO) that is a transparent conductive material. Here, a point where the common electrode included in the pixels is electrically connected to the connection unit, is referred to as an ITO-hole. The common voltage Vcom applied to a pixel is delivered to the common electrode of the pixel via the connection unit. In the case of an LCD device, according to an embodiment of the present invention, the connection unit is patterned so that a first common voltage and a second common voltage may be applied to odd-numbered pixels and even-numbered pixels, respectively.

For example, in the case of mobile Patterned Vertical Align (mPVA) pixels, patterning is performed to form electrodes to which a common voltage CF-Vcom of color filter (CF) glass is applied. Thus, even if there are two common voltage lines, ITO-holes are formed in pixels and connection units are patterned by performing a process without having to use an additional mask. That is, patterning may be performed without an additional process so that odd common voltage lines are disposed separate from even common voltage lines on CF glass.

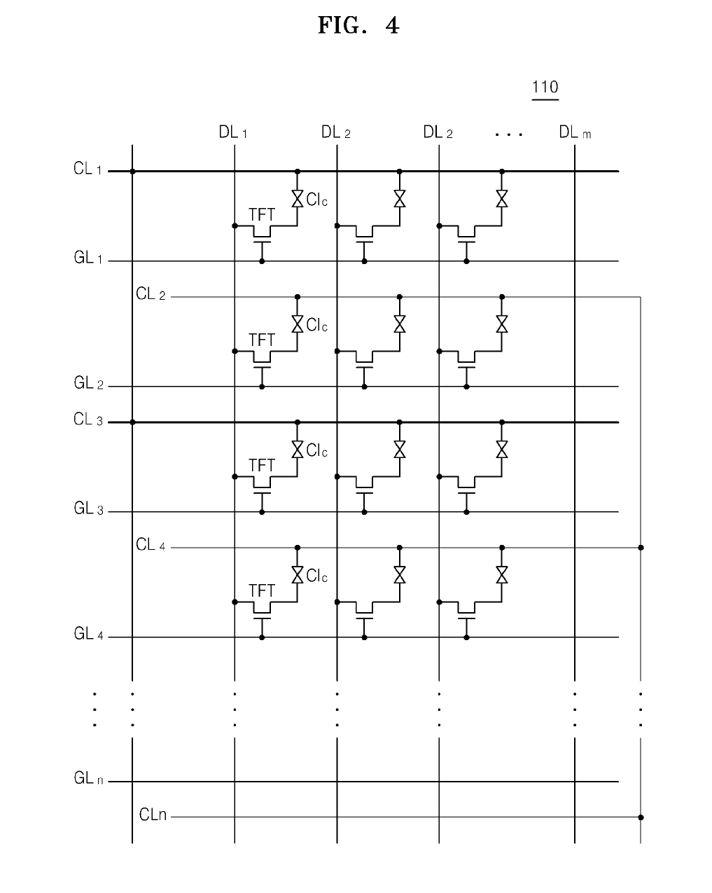

FIG. 4 illustrates in detail the liquid crystal panel 110 of the LCD device illustrated in FIG. 2. Referring to FIG. 4, the LCD device includes n gate lines GL₁, GL₂, GL₃, GL₄, . . . to GLₙ arranged in rows on a liquid crystal panel 110, and m data lines DL₁, DL₂, DL₃, . . . to DLₘ arranged in columns on the liquid crystal panel 110. The LCD device further includes n common voltage lines CL₁, CL₂, CL₃, CL₄, . . . to CLₙ arranged in rows on the liquid crystal panel 110. In the LCD device, n×m pixels are formed at points where the gate lines GL₁, GL₂, GL₃, GL₄, . . . to GLₙ, the data lines DL₁, DL₂, DL₃, . . . to DLₘ, and the common voltage lines CL₁, CL₂, CL₃, CL₄, . . . to CLₙ intersect one another.

The pixels are arranged in a matrix and may thus be divided into pixels in odd-numbered rows and pixels in even-numbered rows. Each of the pixels includes a TFT, a liquid crystal cell Cl_{c}, a pixel electrode, and a common electrode. Although not shown in the drawings, each of the pixels may further include a capacitor and other devices.

The gate lines GL₁, GL₂, GL₃, GL₄, . . . to GLₙ are connected to gate electrodes of the thin film transistors TFT included in the respective pixels. The data lines DL₁, DL₂, DL₃, . . . to DLₘ are connected to source electrodes of TFTs, and drain electrodes of the TFTs are connected to the pixel electrodes of the TFTs. The common voltage lines CL₁, CL₂, CL₃, CL₄, . . . to CLₙ are connected to the common electrodes in the respective pixels.

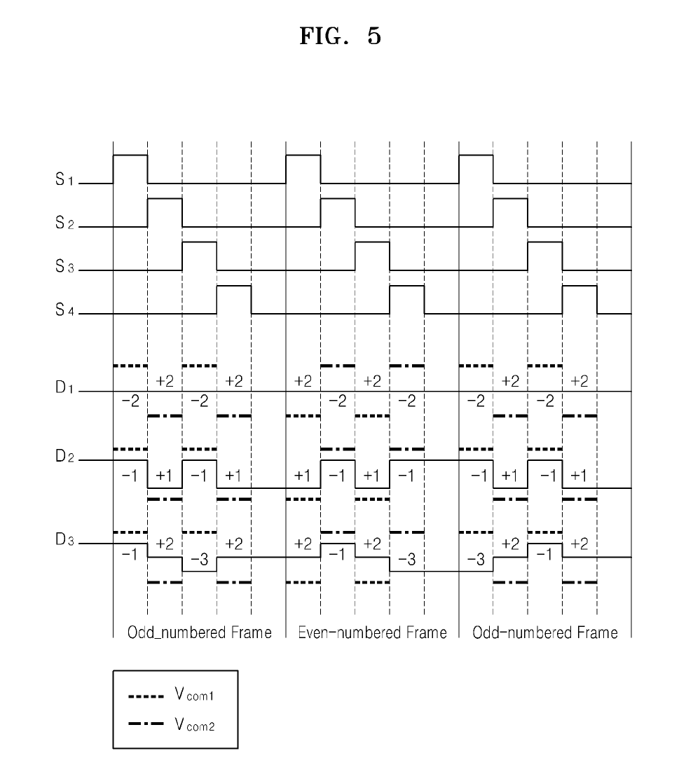

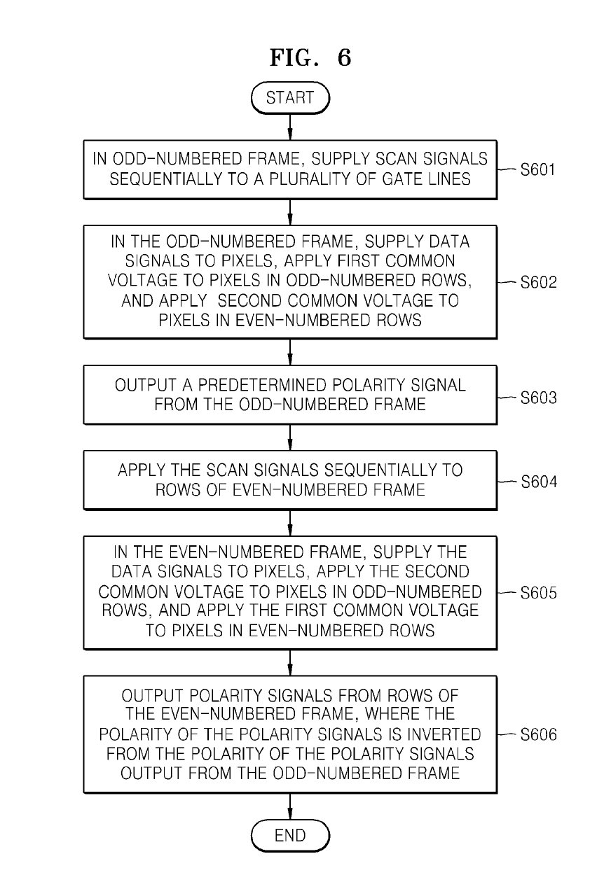

A method of driving the LCD device illustrated in FIG. 4 according to an embodiment of the present invention will now be described with reference to FIGS. 5 and 6. FIG. 5 is a timing diagram of a method of driving an LCD device according to an embodiment of the present invention. FIG. 6 is a flowchart illustrating a method of driving an LCD device according to an embodiment of the present invention.

Referring to FIG. 5, frames are divided into odd-numbered frames and even-numbered frames according to whether polarity inversion is performed. However, aspects of the present invention are not limited thereto and polarity inversion may be performed in units of frames or by other inversion methods. Scan signals S₁, S₂, S₃, and S₄, data signals D₁, D₂, and D₃, and common voltages Vcom1 and Vcom2 are supplied to frames in the form of pulses. The second common voltage Vcom2 is in the form of a pulse whose polarity is inverted compared to that of the pulse of the first common voltage Vcom1.

Referring to FIG. 6, in operation S601, in an odd-numbered frame, the scan signals S₁ to S₄ are supplied sequentially to the gate lines GL₁, GL₂, GL₃, and GL₄ of FIG. 4, respectively. The scan signals S₁ to S₄ are supplied to gate electrodes of TFTs included in respective pixels, and the thin film transistors TFT are thus turned on.

In operation S602, in the odd-numbered frame, the data signals D₁, D₂, and D₃ are supplied to the pixels from the data lines DL₁, DL₂, and DL₃ of FIG. 4, in response to the scan signals S₁ to S₄, the first common voltage Vcom1 is applied to pixels in odd-numbered rows via odd common voltage lines CL₁, and CL₃ of FIG. 4, and the second common voltage Vcom2 is applied to pixels in even-numbered rows via even common voltage lines CL₂, and CL₄ of FIG. 4. Thus, the data signals D₁, D₂, and D₃ are supplied to pixel electrodes via the TFTs turned on, in operation S601. The common voltages Vcom1 and Vcom2 are applied to common electrodes of the pixels.

In operation S603, the pixels have a predetermined polarity according to the data signals D₁ to D₃ and the common voltages Vcom1 and Vcom2. Thus, predetermined polarity signals are output from the odd-numbered frame in rows, respectively. For example, referring to FIG. 5, the first common voltage Vcom1, which is a high voltage, is applied to the pixels in the odd-numbered rows, and thus, voltages of the data signals D₁ to D₃ are lower than the first common voltage Vcom. Accordingly, the pixels in the odd-numbered rows have a negative (−) polarity. The second common voltage Vcom2, which is a low voltage, is applied to the pixels in the even-numbered rows, and thus, voltages of the data signals D₁ to D₃ are higher than the common voltage Vcom2. Accordingly, the pixels in the even-numbered rows have a positive (+) polarity.

Compared to the odd-numbered frame, the scan signals S₁ to S₄ and the data signals D₁ to D₃ are supplied to an even-numbered frame in a similar manner but the polarities of the common voltages Vcom1 and Vcom2 applied to the even-numbered frame are opposite to those of the common voltages Vcom1 and Vcom2 applied to the odd-numbered frame. That is, the polarities of the common voltages Vcom1 and Vcom2 are inverted so that the odd-numbered frame has an opposite polarity to that of the even-numbered frame.

In operation S604, the scan signals S₁ to S₄ are applied sequentially to rows of the even-numbered frame.

In operation S605, in the even-numbered frame, the data signals D₁ to D₃ are supplied to pixels via the data lines DL₁ to DL₄, the second common voltage Vcom2 is applied to pixels in odd-numbered rows via the odd common voltage lines CL₁, and CL₃ of FIG. 4, and the first common voltage Vcom1 is applied to pixels in even-numbered rows via the even common voltage lines CL₂, and CL₄ of FIG. 4, in response to the scan signals S₁ to S₄. Here, the second common voltage Vcom2 is in the form of a pulse whose polarity is inverted compared to that of the pulse of the first common voltage Vcom1.

Thus, the data signals D₁, D₂, and D₃ are supplied to the pixel electrodes via the TFTs turned on in operation S604. The common voltages Vcom1 and Vcom2 are applied to the common electrodes of the pixels.

In operation S606, the pixels have a polarity according to the data signals D₁ to D₃ and the common voltages Vcom1 and Vcom2. Accordingly, polarity signals are output from the even-numbered frame in rows, where the polarity of the polarity signals is inverted from the polarity of the polarity signals output from the odd-numbered frame in operation S603, respectively. That is, referring to FIG. 5, since the second common voltage Vcom2, which is a low voltage, is applied to the pixels in the odd-numbered rows, the voltages of the data signals D₁ to D₃ are higher than the common voltage Vcom2. Accordingly, the pixels in the odd-numbered rows have a positive (+) polarity.

Also, since the first common voltage Vcom1 that is a high voltage is applied to the pixels in the even-numbered rows, the voltages of the data signals D₁ to D₃ are lower than the common voltage Vcom1. Accordingly, the pixels in the even-numbered rows have a negative (−) polarity.

In the current embodiment, the first common voltage Vcom1 is a high voltage and the second common voltage Vcom2 is a low voltage. However, aspects of the present invention are not limited thereto. Referring to FIG. 5, the data signal has an intermediate voltage between a high common voltage and a low common voltage. For example, if a common voltage is a high voltage, e.g., 4V, and a data signal of 2V is supplied to a pixel, then the pixel has a voltage of −2V and thus has a negative polarity. If the common voltage is a low voltage, e.g., 0V, and the data signal of 2V is supplied to the pixel, then the pixel has a voltage of +2V and thus has a positive polarity.

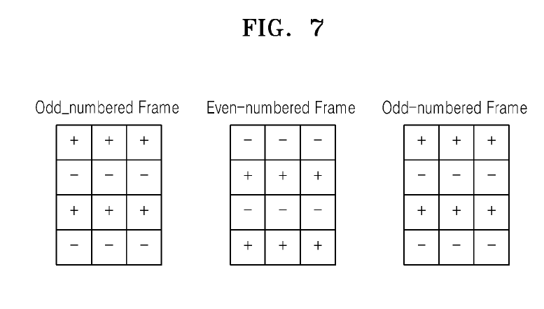

FIG. 7 illustrates polarities of frames in an LCD device based on the timing diagram of FIG. 5, according to an embodiment of the present invention. Referring to FIG. 7, in an odd-numbered frame, pixels in odd-numbered rows have a positive (+) polarity. In an even-numbered frame, pixels in even-numbered rows have a positive (+) polarity. That is, the polarity is the same in respective rows in odd-numbered frames and even-numbered frames, and polarity inversion occurs whenever one frame is switched to another frame, or in other words, when an even-numbered frame is switched to an odd-numbered frame.

In the current embodiment, a common voltage is maintained continuously at a high or low level for the duration of one frame, e.g., an odd or even-numbered frame, but a level of a common voltage applied to an odd-numbered frame is different from that of a level of a common voltage applied to an even-numbered frame. Accordingly, if a frame inversion driving method is used, it is possible to derive an effect obtained when line inversion is performed.

Conventionally, when an LCD device is driven using line inversion, a common voltage is inverted in units of gate lines when a data signal is supplied. In this case using line inversion, the number of times that switching is performed between a positive polarity and a negative polarity is greater than when frame inversion is used to drive an LCD device. Thus, power consumption is increased in a common voltage driving unit when using line inversion compared to frame inversion.

Also, conventionally, to allow pixels of a frame to alternately have positive and negative polarities, inversion driving is performed by maintaining a common voltage at a constant level and increasing the voltage range of output data signals. However, this method is disadvantageous because the voltage range of output data signals is high, with respect to other methods, and power consumption in a data driving unit is thus too high.

However, according to aspects of the present invention, an LCD device is driven using line inversion consuming approximately the same amount of power as needed when frame inversion is used by inverting a common voltage of pixels of each frame in odd and even-numbered rows from a high level to a low level and vice versa. Accordingly, it is possible to enhance the quality of an image displayed in high-resolution display devices and to reduce the voltage range of output data signals and the amount of power consumption in a data driving unit.

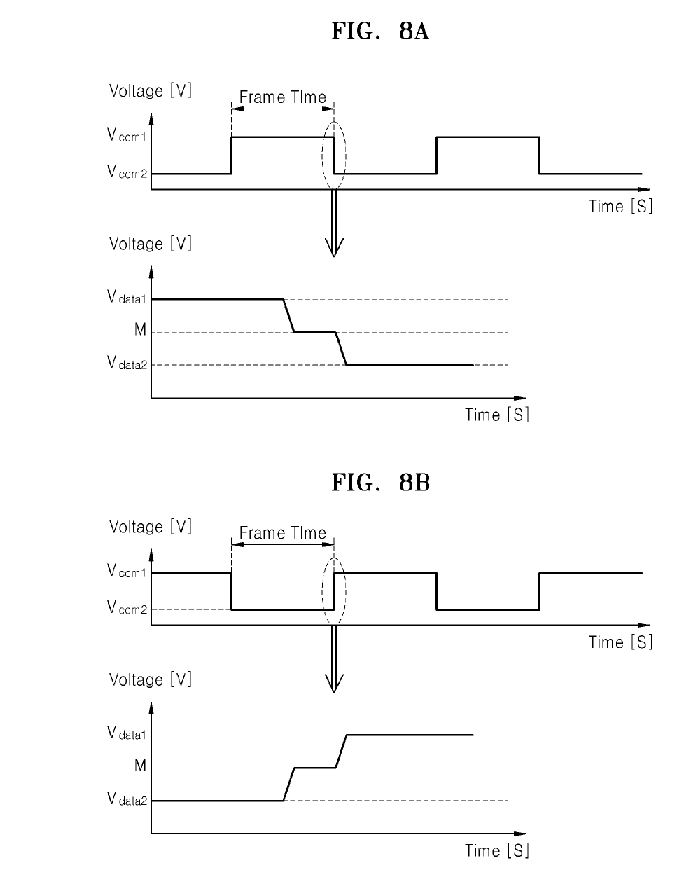

FIGS. 8A and 8B illustrate the results of applying charge sharing to an LCD device according to an embodiment of the present invention. Charge sharing is a technique whereby switching is performed such that electric charges are shared by adjacent lines and each line has an intermediate voltage owing to charge redistribution, thereby reducing power consumption.

In detail, FIG. 8A illustrates a variation in a common voltage of a common voltage line in an odd-numbered row, wherein time is measured in units of frames. For example, a common voltage driving unit applies a first common voltage Vcom1, which is a high voltage, to a common voltage line in an odd-numbered row for a duration of a frame and then applies a second common voltage Vcom2, which is a low voltage, to a common voltage line in another odd-numbered row when the frame is switched to another frame.

Similarly, FIG. 8B illustrates a variation in a common voltage of a common voltage line in an even-numbered row, wherein time is measured in units of frames. A common voltage applied by the common voltage driving unit, for the duration of a frame, to a common voltage line in an even-numbered row is in the form of a pulse waveform whose polarity is inverted as compared to that of a pulse waveform of the common voltage of the corresponding common voltage line in the odd-numbered row.

As described above, power consumption in a common voltage driving unit may be reduced by performing common voltage charge sharing in units of rows in each frame at the moment that switching is performed between a low voltage and a high voltage, as illustrated in FIGS. 8A and 8B.

In an LCD device according to an embodiment of the present invention, the polarity of a common voltage applied to a common voltage line for every odd or every even-numbered frame is inverted with respect to each other. In this case, polarity inversion is performed using the driving force of a common voltage driving unit. Referring to FIGS. 8A and 8B, charge sharing is used when the polarity of a common voltage applied in odd or even-numbered rows is inverted. For example, it is assumed that a high voltage is switched to a low voltage in an odd-numbered row, as illustrated in FIG. 8A, and the low voltage is switched to the high voltage, as illustrated in FIG. 8B. In this case, charge sharing is performed from the high or low voltage to an intermediate voltage M and the IC driving force of the common voltage driving unit is used between the intermediate voltage M and the other of the low or high voltage.

According to an embodiment of the present invention, charge sharing may be performed by installing a switch between a first common voltage line and a second common voltage line. Alternatively, the switch may be installed either on a liquid crystal panel or on a common voltage driving unit. Charge redistribution may be performed by turning on the switch in a section where charge sharing is needed, so that the first common voltage line and the second common voltage line are short-circuited. The principles and operations of charge sharing have already been disclosed and thus are not described here.

If charge sharing is applied when the polarity of a common voltage is inverted, then the load on a circuit for driving a common voltage driving unit is reduced. Also, the range of voltage driven by the common voltage driving unit may be reduced, thereby reducing power consumption.

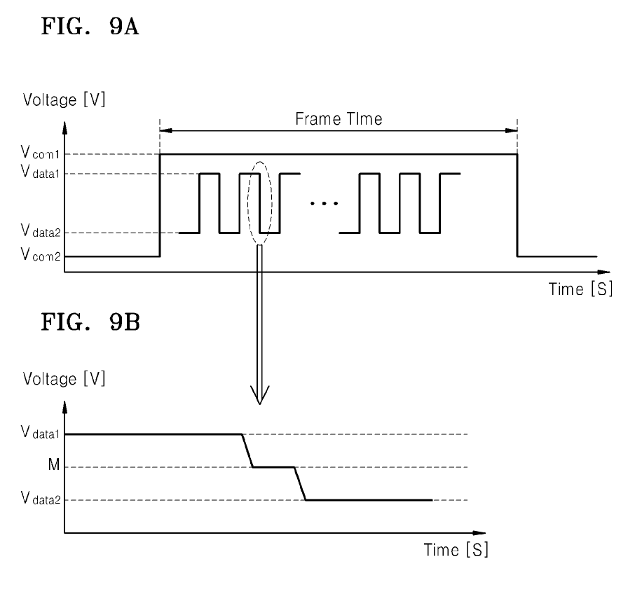

FIGS. 9A and 9B illustrate the results of applying charge sharing to a data signal according to an embodiment of the present invention. The charge sharing illustrated in FIGS. 9A and 9B is performed similar to the charge sharing described with respect to FIGS. 8A and 8B. Furthermore, a method, function, purpose, and effects of charge sharing illustrated in FIGS. 9A and 9B have been described above with reference to FIGS. 8A and 8B.

FIG. 9A illustrates a common voltage and a data signal for the duration of a frame. Referring to FIG. 9A, the logic level of the data signal falls and rises within the range of a high level to a low level of the common voltage.

Referring to FIG. 9B, charge sharing is applied between a high data voltage Vdata1 and an intermediate voltage M when the voltage of the data signal changes from the high data voltage Vdata1 to a low data voltage Vdata2 and the driving force of a data driving unit is used between the intermediate voltage M and the low data voltage Vdata2, and vice versa.

According to the above embodiments of the present invention, it is possible to drive an LCD device by using frame inversion while deriving the effect obtained when line inversion is used.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A liquid crystal display comprising:
a liquid crystal panel having n gate lines and m data lines intersecting one another to form a frame to display an image;
a gate driving unit respectively supplying a plurality of scan signals to the n gate lines arranged in rows on the liquid crystal panel;
a data driving unit respectively supplying a plurality of data signals to the m data lines arranged in columns on the liquid crystal panel; and
a common voltage driving unit applying a first common voltage to a plurality of odd common voltage lines arranged in rows on the liquid crystal panel, and applying a second common voltage to a plurality of even common voltage lines arranged in rows on the liquid crystal panel,
wherein the odd common voltage lines and the even common voltage lines are alternately arranged.

2. The liquid crystal display of claim 1, wherein pixels in odd-numbered rows are connected to the odd common voltage lines, and
wherein pixels in even-numbered rows are connected to the even common voltage lines.

3. The liquid crystal display of claim 1, wherein the frame is divided into an odd-numbered frame and an even-numbered frame, and
wherein common voltage polarity inversion is performed such that a polarity of the odd-numbered frame is opposite to a polarity of the even-numbered frame.

4. The liquid crystal display of claim 3, wherein, in the odd-numbered frame, the common voltage driving unit applies the first common voltage to the odd common voltage lines and applies the second common voltage to the even common voltage lines, and
in the even-numbered frame, the common voltage driving unit applies the second common voltage to the odd common voltage lines and applies the first common voltage to the even common voltage lines.

5. The liquid crystal display of claim 3, wherein charge sharing is applied between the first common voltage and the second common voltage in order to perform common voltage polarity inversion.

6. The liquid crystal display of claim 1, wherein a polarity of a pulse waveform of the first common voltage is inverted compared to a polarity of a pulse waveform of the second common voltage.

7. A method of driving a liquid crystal display device having a liquid crystal panel, gate lines supplying a plurality of scan signals, data lines supplying a plurality of data signals, a plurality of odd common voltage lines applying a first common voltage and being arranged in rows on the liquid crystal panel, and a plurality of even common voltage lines applying a second common voltage and being arranged in rows on the liquid crystal panel, such that the odd common voltage lines and even common voltage lines are alternately arranged, the method comprising:
supplying, respectively, the plurality of scan signals to gate electrodes in an odd-numbered frame or an even-numbered frame; and
applying, respectively, the plurality of data signals and a first common voltage or a second common voltage, having a first polarity, to pixels in rows, in response to the scan signals.

8. The method of claim 7, wherein the supplying in the odd-numbered frame comprises:
supplying a first scan signal to a first gate line connected to pixels in a first row;
supplying a data signal to the pixels in the first row, via one of the data lines, and applying the first common voltage to the pixels in the first row, via one of the odd common voltage lines, in response to the first scan signal so that the pixels in the first row have a predetermined polarity;
supplying a second scan signal to a second gate line connected to pixels in a second row; and
supplying a data signal to the pixels in the second row, via one of the data lines, and applying the second common voltage to the pixels in the second row, via one of the even common voltage lines, in response to the second scan signal so that the pixels in the second row have a predetermined polarity.

9. The method of claim 7, the supplying in the even-numbered frame, comprises:
supplying a first scan signal to a first gate line connected to pixels in a first row;
supplying a data signal to the pixels in the first row, via one of the data lines, and applying the second common voltage to the pixels in the first row, via one of the odd common voltage lines, in response to the first scan signal so that the pixels in the first row have a predetermined polarity;
supplying a second scan signal to a second gate line connected to pixels in a second row; and
supplying a data signal to the pixels in the second row, via one of the data lines, and applying the first common voltage to the pixels in the second row, via one of the even common voltage lines, in response to the second scan signal so that the pixels in the second row have a predetermined polarity.

10. The method of claim 7, wherein a polarity of a pulse waveform of the first common voltage is inverted compared to a polarity of a pulse waveform of the second common voltage.

11. The method of claim 8, wherein the pixels in the first row are connected to one of the odd common voltage lines, and
wherein the pixels in the second row are connected to one of the even common voltage lines.

12. The liquid crystal display of claim 1, wherein the liquid crystal panel displays an image frame.

13. The liquid crystal display of claim 12, wherein the image frame is divided into an odd numbered frame and an even numbered frame, and
wherein common voltage polarity inversion is performed such that a polarity of the odd numbered frame is opposite to a polarity of an even numbered frame.

14. A method of driving a liquid crystal panel of a liquid crystal display device having gate lines supplying a scan signal, data lines supplying a data signal, a plurality of odd common voltage lines applying a first common voltage and being arranged in rows on the liquid crystal panel, and a plurality of even common voltage lines applying a second common voltage and being arranged in rows on the liquid crystal panel, such that the odd common voltage lines and the even common voltage lines are alternately arranged, the method comprising:
dividing a frame displayed on the liquid crystal panel into an odd numbered frame and an even numbered frame;
displaying the odd numbered frame according to scan signals and data signals corresponding to the odd numbered frame; and
displaying the even numbered framed according to scan signals and data signals corresponding to the even numbered frame.

15. The method of claim 14, wherein the displaying the odd numbered frame comprises:
supplying a first scan signal to a first gate line connected to pixels in a first row;
supplying a data signal to the pixels in the first row and applying the first common voltage to the pixels in the first row in response to the first scan signal so that the pixels in the first row have a predetermined polarity;
supplying a second scan signal to a second gate line connected to pixels in a second row; and
supplying a data signal to the pixels in the second row and applying the second common voltage to the pixels in the second row in response to the second scan signal so that the pixels in the second row have a predetermined polarity.

16. The method of claim 7, in the even-numbered frame, further comprising:
supplying a first scan signal to a first gate line connected to pixels in a first row;
supplying a data signal to the pixels in the first row and applying the second common voltage to the pixels in the first row in response to the first scan signal so that the pixels in the first row have a predetermined polarity;
supplying a second scan signal to a second gate line connected to pixels in a second row; and
supplying a data signal to the pixels in the second row and applying the first common voltage to the pixels in the second row in response to the second scan signal so that the pixels in the second row have a predetermined polarity.

17. The method of claim 7, wherein a polarity of a pulse waveform of the first common voltage is inverted compared to a polarity of a pulse waveform of the second common voltage.
